(19) United States
(12) Patent Application Publication
(10) Pub. No.: US 2026/0149882 A1
(43) Pub. Date: May 28, 2026

(54) IMAGING APPARATUS

(71) Applicant: Panasonic Intellectual Property Management Co., Ltd., Osaka (JP)

(72) Inventor: Shusaku NAKATA, Osaka (JP)

(73) Assignee: Panasonic Intellectual Property Management Co., Ltd., Osaka (JP)

(21) Appl. No.: 19/392,456

(22) Filed: Nov. 18, 2025

(30) Foreign Application Priority Data
Nov. 25, 2024 (JP) 2024-204685
Sep. 30, 2025 (JP) 2025-163604

(51) Int. Cl. H04N 23/68; H04N 23/73

(52) U.S. Cl. CPC H04N 23/687; H04N 23/73

(57) ABSTRACT

An imaging apparatus includes an image sensor that captures a subject image formed via an optical system to generate image data, an optical image stabilizer, an electronic image stabilizer, and a controller that controls the optical image stabilizer and the electronic image stabilizer. The optical image stabilizer performs image stabilization by moving the image sensor within a plane perpendicular to an optical axis of the optical system. The electronic image stabilizer performs image stabilization by applying image processing to the image data. The optical system compresses the subject image more in a first direction orthogonal to the optical axis than in a second direction orthogonal to the optical axis. The optical image stabilizer corrects a rotational shake in a rotational direction about the optical axis. The electronic image stabilizer corrects a shearing resulting from compression of the subject image by the optical system in a state where the rotational shake is corrected by the optical image stabilizer.

### TECHNICAL FIELD

The present disclosure relates to an imaging apparatus having an image stabilization function.

### BACKGROUND ART

JP 2021-150737 A discloses an image processing apparatus for correcting an image shake around the optical axis as the rotation center, in an image captured using a special lens forming an optical image compressed in one direction. This image processing apparatus includes an image deformation unit that applies correction processing for correcting a rotational deformation in a subject image, the rotational deformation caused by a device shake about an optical axis, and a geometric deformation processing including shearing processing, to the image data.

### SUMMARY

The present disclosure provides an imaging apparatus capable of correcting an image shake appropriately when using an optical system that compresses a subject image in one direction more than in other directions.

An imaging apparatus according to one aspect of the present disclosure includes an image sensor that captures a subject image formed via an optical system to generate image data, an optical image stabilizer, an electronic image stabilizer, and a controller that controls the optical image stabilizer and the electronic image stabilizer. The optical image stabilizer performs image stabilization by moving the image sensor within a plane perpendicular to an optical axis of the optical system. The electronic image stabilizer performs image stabilization by applying image processing to the image data. The optical system compresses the subject image more in a first direction orthogonal to the optical axis than in a second direction orthogonal to the optical axis. The optical image stabilizer corrects a rotational shake in a rotational direction about the optical axis. The electronic image stabilizer corrects a shearing resulting from compression of the subject image by the optical system in a state where the rotational shake is corrected by the optical image stabilizer.

According to the imaging apparatus of the present disclosure, it is possible to correct an image shake appropriately when using an optical system that compresses a subject image in one direction more than in other directions.

### BRIEF DESCRIPTION OF DRAWINGS

FIG. 1 is a perspective view of a digital camera according to a first embodiment of the present disclosure;

FIG. 2 is a block diagram illustrating a configuration of the digital camera according to the first embodiment;

FIG. 3 is a block diagram illustrating configurations of a BIS processor and an EIS processor in the digital camera according to the first embodiment;

FIG. 4 is a block diagram illustrating a configuration of an OIS processor in the digital camera according to the first embodiment;

FIG. 5A is a schematic diagram for describing a problem in correcting a rotational shake in a digital camera on which an anamorphic lens is mounted;

FIG. 5B is a schematic diagram for describing a problem in correcting a rotational shake in a digital camera on which an anamorphic lens is mounted;

FIG. 5C is a schematic diagram for describing a problem in correcting a rotational shake in a digital camera on which an anamorphic lens is mounted;

FIG. 5D is a schematic diagram for describing a problem in correcting a rotational shake in a digital camera on which an anamorphic lens is mounted;

FIG. 5E is a schematic diagram for describing a problem in correcting a rotational shake in a digital camera on which an anamorphic lens is mounted;

FIG. 5F is a schematic diagram for describing a problem in correcting a rotational shake in a digital camera on which an anamorphic lens is mounted;

FIG. 5G is a schematic diagram for describing a problem in correcting a rotational shake in a digital camera on which an anamorphic lens is mounted;

FIG. 6A is a schematic diagram for describing an operation for correcting a rotational shake in the digital camera according to the first embodiment;

FIG. 6B is a schematic diagram for describing an operation for correcting a rotational shake in the digital camera according to the first embodiment;

FIG. 6C is a schematic diagram for describing an operation for correcting a rotational shake in the digital camera according to the first embodiment;

FIG. 6D is a schematic diagram for describing an operation for correcting a rotational shake in the digital camera according to the first embodiment;

FIG. 6E is a schematic diagram for describing an operation for correcting a rotational shake in the digital camera according to the first embodiment;

FIG. 6F is a schematic diagram for describing an operation for correcting a rotational shake in the digital camera according to the first embodiment;

FIG. 7 is a flowchart illustrating an optical correction operation performed by the digital camera according to the first embodiment;

FIG. 8 is a flowchart illustrating an electronic correction operation performed by the digital camera according to the first embodiment;

FIG. 9 is a diagram for describing optical correction processing for correcting a rotational shake, according to the first embodiment;

FIG. 10A is a graph illustrating an example of a temporal change in a rotational shake in a roll direction when a stationary photographer captures an image using a conventional digital camera;

FIG. 10B is a graph illustrating an example of a temporal change in the rotational shake in the roll direction during a walking shot;

FIG. 10C is a graph illustrating an example of a temporal change in the rotational shake in the roll direction during a running shot;

FIG. 11 is a schematic diagram for describing how blur becomes apparent in a conventional digital camera;

FIG. 12 is a flowchart illustrating optical correction processing performed by a digital camera in a second embodiment;

FIG. 13 is a graph illustrating an example of a relationship between the exposure time and an EIS ratio, in the digital camera according to the second embodiment;

FIG. 14 is a flowchart illustrating an operation of a digital camera according to a first modification;

FIG. 15 is a diagram for describing optical correction processing for correcting a rotational shake in a third modification; and

FIG. 16 is a flowchart for describing processing of distributing a shake correction amount in a seventh modification.

### DETAILED DESCRIPTION

Hereinafter, embodiments of the present disclosure will be described with reference to the drawings as appropriate. However, in the detailed description, unnecessary parts in descriptions of the conventional technique and the substantially same configuration may be omitted. The following description and the accompanying drawings are provided so that those skilled in the art can fully understand the present disclosure, and not intended to limit the subject matter of the claims.

### First Embodiment

### 1. Configuration

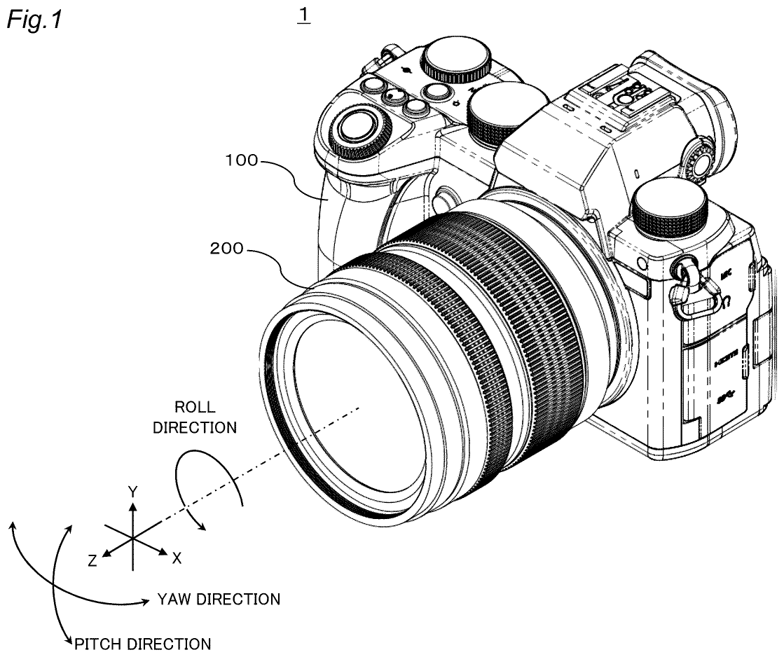

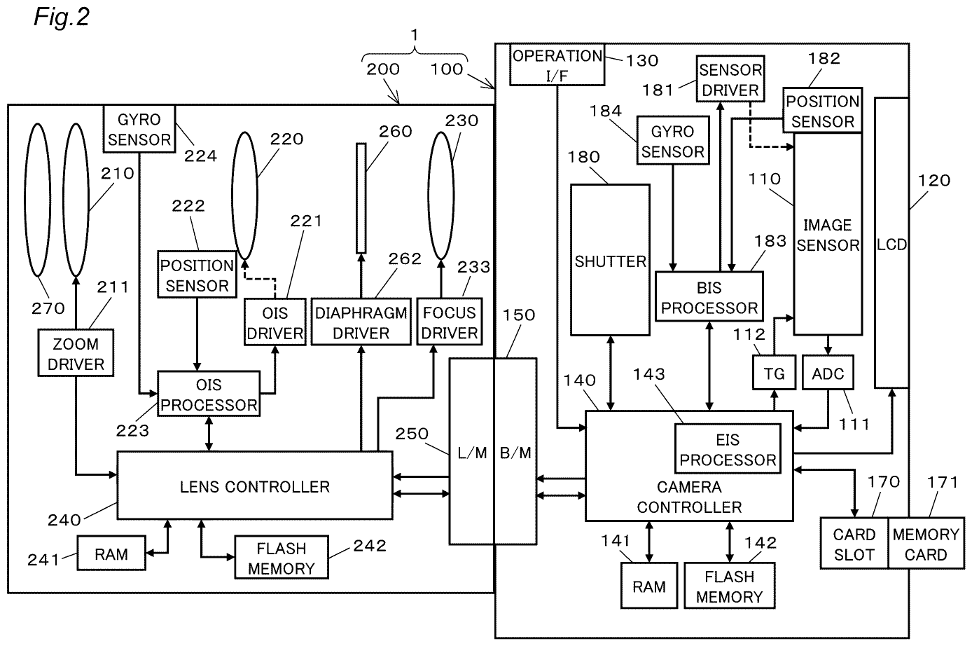

FIG. 1 is a perspective view of a digital camera 1 according to a first embodiment of the present disclosure. FIG. 2 is a block diagram illustrating a configuration of the digital camera 1 according to the first embodiment. The digital camera 1 is an example of an imaging apparatus including a camera body 100 and an interchangeable lens 200 that is removable from the camera body 100.

In the description below, a function for correcting shake by moving a correction lens included in the interchangeable lens 200 is referred to as an “optical image stabilizer (OIS) function”. A function for correcting shake by moving an image sensor in the camera body 100 is referred to as a “body image stabilizer (BIS) function”. Correction of shake with the use of the OIS function and the BIS function is collectively referred to as an “optical correction”. Correction of shake by applying image processing to the image data captured by the image sensor is referred to as an “electronic correction”, and a function for performing the electronic correction is referred to as an “electronic image stabilizer (EIS) function”.

In the description below, the direction about the X axis (that is, the tilt direction) corresponding to the horizontal direction of the digital camera 1 is referred to as a pitch direction, and the direction about the Y axis (that is, the pan direction) corresponding to the vertical direction is referred to as a yaw direction (see FIG. 1). The direction in which the imaging surface of the image sensor of the digital camera 1 is rotated on a plane orthogonal to the optical axis (a direction about the Z axis) is referred to as a roll direction (see FIG. 1).

### 1-1. Camera Body

The camera body 100 includes an image sensor 110, a liquid crystal monitor 120, an operation interface 130, a camera controller 140, a RAM 141, a flash memory 142, a body mount 150, a card slot 170, and a shutter 180. The camera body 100 also includes an EIS processor 143 that implements an EIS function as a functional configuration of the camera controller 140, for example.

The camera controller 140 controls the entire operation of the digital camera 1 by controlling components such as the image sensor 110 according to an instruction from a release button. The camera controller 140 transmits a vertical synchronization signal to a timing generator (TG) 112. In parallel with this vertical synchronization signal, the camera controller 140 generates an exposure synchronization signal. The camera controller 140 transmits the generated exposure synchronization signal periodically to a lens controller 240 via the body mount 150 and a lens mount 250. The camera controller 140 uses the RAM 141 as a work memory during control operation and image processing operation.

The image sensor 110 is an example of an imaging sensor that captures a subject image being incident thereon through the interchangeable lens 200 to generate image data. The image sensor 110 is, for example, a CCD, a CMOS image sensor, or an NMOS image sensor. The generated image data is digitized by an AD converter (ADC) 111. The digitized image data is subjected to predetermined image processing by the camera controller 140. The predetermined image processing is, for example, gamma correction processing, white balance correction processing, scratch correction processing, YC conversion processing, electronic zoom processing, and/or JPEG compression processing.

The image sensor 110 is operated at a timing controlled by the timing generator 112. The image sensor generates a still image or a moving image for recording, or a through image. The through image is mainly a moving image, and is displayed on the liquid crystal monitor 120 in order for a user to determine a composition for capturing a still image.

The liquid crystal monitor 120 displays various kinds of information such as an image, e.g., the through image, and a menu screen. The liquid crystal monitor 120 is an example of a display in the embodiment. Instead of the liquid crystal monitor, another type of display device, for example, an organic EL display device may be used.

The operation interface 130 includes various operation members such as a release button for instructing to start capturing an image, a mode dial for setting an image capturing mode, and a power switch. The operation interface 130 also includes a touch panel superimposed over the liquid crystal monitor 120.

The RAM 141 is a recording medium that functions as a work memory of the camera controller 140. The RAM 141 temporarily stores (i.e., holding or buffering), for example, image data generated by the image sensor 110, various types of setting information in the digital camera 1, and the like. The flash memory 142 is a nonvolatile recording medium. For example, the flash memory 142 stores a predetermined setting value and the like in the digital camera 1. Each of the RAM 141 and the flash memory 142 is an example of a storage of the digital camera 1 according to the present embodiment.

The card slot 170 can be inserted with a memory card 171, and the card slot 170 controls the memory card 171 under the control of the camera controller 140. The digital camera 1 can store image data in the memory card 171, and read the image data from the memory card 171.

The shutter 180 adjusts exposure time (time of exposure) for the light becoming incident on the image sensor 110. The shutter 180 is driven by a drive system such as a DC motor or a stepping motor according to a control signa issued from the camera controller 140. For example, the camera controller 140 can control a shutter speed (exposure time) by controlling a drive speed at which the shutter 180 is driven.

The body mount 150 may be mechanically and electrically connected to the lens mount 250 of the interchangeable lens 200. The body mount 150 can transmit and receive data to and from the interchangeable lens 200 via the lens mount 250. The body mount 150 transmits the exposure synchronization signal received from the camera controller 140 to the lens controller 240 via the lens mount 250. Other control signals received from the camera controller 140 are transmitted to the lens controller 240 via the lens mount 250. The body mount 150 transmits signals received from the lens controller 240 via the lens mount 250 to the camera controller 140.

The camera body 100 further includes, as a configuration that realizes the BIS function, a gyro sensor 184 (shake detector) that detects the vibration of the camera body 100, and a BIS processor 183 that controls shake correction processing based on a detection result of the gyro sensor 184. The camera body 100 further includes a sensor driver 181 that moves the image sensor 110, and a position sensor 182 that detects a position of the image sensor 110.

The sensor driver 181 can be realized by, for example, a magnet and a flat coil. The sensor driver 181 may include another motor, an actuator, or the like. The position sensor 182 is a sensor that detects the position of the image sensor 110 in a plane perpendicular to the optical axis of the optical system. The position of the image sensor 110 may be defined as a position in a two-dimensional plane perpendicular to the optical axis. For example, the position of the image sensor 110 can be defined as a displacement amount along each direction of two orthogonal axes (X-axis and Y-axis) from a predetermined reference position of the image sensor 110. The position sensor 182 can be realized by, for example, three sets of magnets and Hall elements. For example, two of the three sets are arranged in the X-axis direction, the other set is arranged in the Y-axis direction (or two sets are in the Y-axis direction, and one set is in the X-axis direction), and each of the sets detects a position in the X-axis direction or the Y-axis direction. The position sensor 182 detects each of the positions in the X-axis direction, the Y-axis direction, and the rotational direction by the rotation axis along the optical axis with respect to the reference position of the image sensor 110, from a relationship between results of the detection.

In the position sensor 182, each of the Hall elements is attached to the image sensor 110, and each of the magnets is fixedly disposed on the camera body 100. As an example, explanation is given for a set of a magnet and a Hall element in the X-axis direction. The Hall element detects a magnetic flux density that changes depending on the relative position of the Hall element with respect to the magnet. By preparing a correspondence relationship between a magnitude of the magnetic flux density and the relative position in advance, it is possible to acquire the relative position corresponding to the magnitude of the magnetic flux density detected by the Hall element. The acquired relative position indicates the position of the image sensor 110 in the X-axis direction. For example, the position of the image sensor 110 in the Y-axis direction and the rotation direction can be similarly acquired. As a result, for example, the position sensor 182 outputs a signal indicating the detected position of the image sensor 110 (also referred to as a “position signal”) to the BIS processor 183.

Based on the signal from the gyro sensor 184 and the signal from the position sensor 182, the BIS processor 183 controls the sensor driver 181 to shift the image sensor 110 within a plane perpendicular to the optical axis so as to offset shake of the camera body 100. A range in which the image sensor 110 can be driven by the sensor driver 181 is mechanically limited. The range where the image sensor 110 can be driven by the sensor driver 181 in the BIS function will be referred to as an “element drive range”.

### 1-2. Interchangeable Lens

The interchangeable lens 200 includes an optical system, the lens controller 240, and the lens mount 250. The optical system includes an anamorphic lens 270, a zoom lens 210, an optical image stabilizer (OIS) lens 220, a focus lens 230, and a diaphragm 260. The optical system including the anamorphic lens 270 may be referred to as an “anamorphic optical system”.

The anamorphic lens 270 compresses the subject image more in a first direction orthogonal to the optical axis than in a second direction orthogonal to the optical axis. The first direction may be different from the second direction. The first direction and the second direction are orthogonal to each other, as an example. The anamorphic lens 270 is a lens that forms an image by converting the aspect ratio of the subject image.

In the present embodiment, the anamorphic lens 270 does not compress the subject image in the Y direction illustrated in FIG. 1, but compresses the subject image in the X direction. In this manner, the anamorphic lens 270 may be an optical system that compresses a subject image in a specific direction. The anamorphic lens 270 includes one or more lenses.

The zoom lens 210 is a lens for changing magnification of a subject image formed by the optical system. The zoom lens 210 includes one or more lenses. The zoom lens 210 is driven by a zoom driver 211. The zoom driver 211 includes a zoom ring that can be operated by the user. Alternatively, the zoom driver 211 may include a zoom lever and an actuator or a motor. The zoom driver 211 moves the zoom lens 210 along a direction of the optical axis of the optical system according to the operation by the user.

The focus lens 230 is a lens for changing a focus state of a subject image formed on the image sensor 110 in the optical system. The focus lens 230 includes one or more lenses. The focus lens 230 is driven by a focus driver 233.

The focus driver 233 includes an actuator or a motor, and moves the focus lens 230 along the optical axis of the optical system based on the control of the lens controller 240. The focus driver 233 can be realized by a DC motor, a stepping motor, a servo motor, an ultrasonic motor, or the like.

The OIS lens 220 is a lens for correcting shake of a subject image formed by the optical system of the interchangeable lens 200 in the OIS function. The OIS lens 220 moves in a direction by which the shake of the digital camera 1 is canceled, and thus reduces the shake of the subject image on the image sensor 110. The OIS lens 220 includes one or more lenses. The OIS lens 220 is driven by an OIS driver 221.

Under the control of an OIS processor 223, the OIS driver 221 shifts the OIS lens 220 in a plane perpendicular to the optical axis of the optical system. A range in which the OIS lens 220 can be driven by the OIS driver 221 is mechanically limited. The range in which the OIS lens 220 can be driven by the OIS driver 221 is referred to as a “lens drive range”. The OIS driver 221 can be realized by, for example, a magnet and a flat coil. A position sensor 222 is a sensor that detects a position of the OIS lens 220 within the plane perpendicular to the optical axis of the optical system, for example, by the similar principle to the position sensor 182 of the camera body 100. The position sensor 222 can be realized by, for example, a magnet and a Hall element. The OIS processor 223 controls the OIS driver 221 based on an output of the position sensor 222 and an output of a gyro sensor 224 (shake detector).

The diaphragm 260 adjusts the amount of light becoming incident on the image sensor 110. The diaphragm 260 is driven by a diaphragm driver 262 so that a size of an opening of the diaphragm 260 is controlled. The diaphragm driver 262 includes a motor or an actuator.

The gyro sensor 184 or 224 detects shake (vibration) in the yaw direction, the pitch direction, and the roll direction based on an angular change of the digital camera 1 per unit time, that is, an angular velocity. The gyro sensor 184 or 224 outputs an angular velocity signal indicating the detected amount of vibration (angular velocity) to the BIS processor 183 or the OIS processor 223. The angular velocity signal output by the gyro sensor 184 or 224 may include a wide range of frequency components due to camera shake, a mechanical noise, or the like. Instead of the gyro sensor, another sensor capable of detecting shake of the digital camera 1 can be used. In addition, the gyro sensor 224 of the interchangeable lens 200 may not detect shake in the roll direction.

The camera controller 140, the lens controller 240, the OIS processor 223, and the BIS processor 183 may be configured by a hard-wired electronic circuit, or may be configured by a microcomputer using a program, or the like. For example, the camera controller 140 and the lens controller 240 can be realized by various processors such as a CPU, an MPU, a GPU, a DSU, an FPGA, or an ASIC. The camera controller 140, the lens controller 240, the OIS processor 223, and the BIS processor 183 may be implemented by independent processors or one processor. Each of the camera controller 140, the lens controller 240, the OIS processor 223, and the BIS processor 183 is an example of a controller in the digital camera 1 according to the present embodiment.

### 1-3. Configuration of Image Stabilizing Function

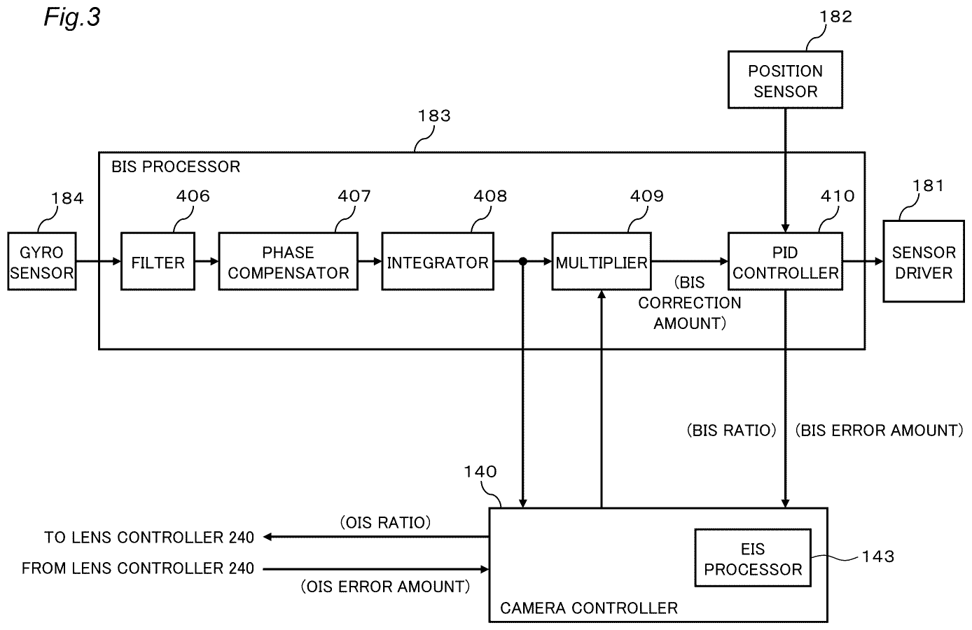

A configuration for realizing various image stabilization functions of the digital camera 1 in the present embodiment will be described with reference to FIGS. 3 to 5.

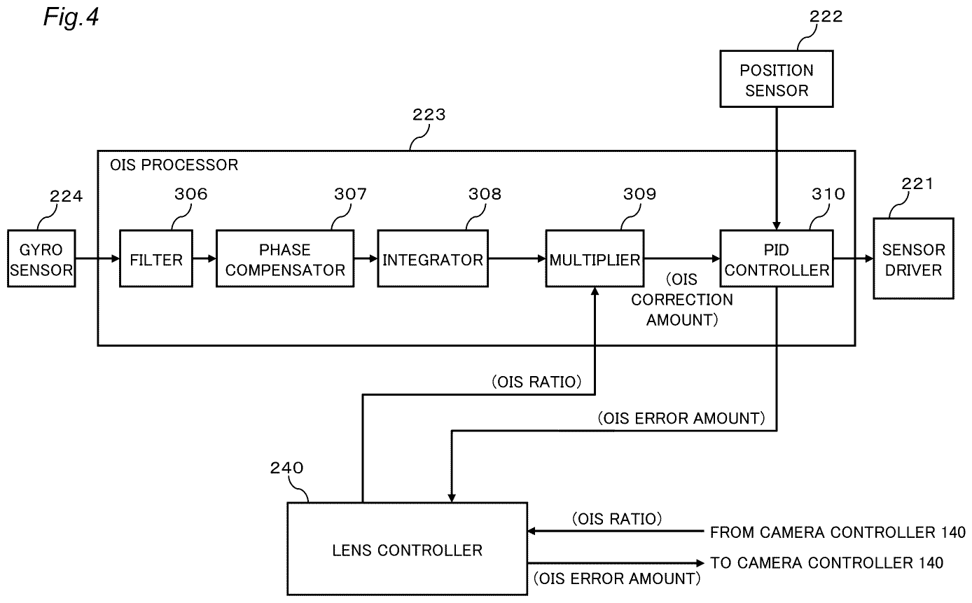

FIG. 3 is a block diagram illustrating configurations of the BIS processor 183 and the EIS processor 143 in the digital camera 1 according to the present embodiment. FIG. 4 is a block diagram illustrating a configuration of the OIS processor 223 in the digital camera 1.

As illustrated in FIG. 3, the digital camera 1 according to the present embodiment includes, for example, as a functional configuration of the camera controller 140, the EIS processor 143 that implements an EIS function. The camera controller 140 sets, as ratios for distributing a shake correction amount in advance, a correction allocation including an OIS ratio indicating an allocation to the OIS processor 223, a BIS ratio indicating an allocation to the BIS processor 183, and an EIS ratio indicating an allocation to the EIS processor 143. Each of the OIS ratio, the BIS ratio, and the EIS ratio includes a yaw direction component, a pitch direction component, and a roll direction component, for example.

In the present embodiment, the digital camera 1 causes the camera controller 140 and the processors 183, 223, and 143 to set these shake correction amounts (also referred to as “correction amounts”) to be corrected by various respective image stabilization functions, for example.

### 1-3-1. OIS Processor

For example, the camera controller 140 transmits information indicating the OIS ratio to the lens controller 240 of the interchangeable lens 200 via each mount 150, 250, and performs setting for the OIS processor 223.

A configuration of the OIS processor 223 in the interchangeable lens 200 will be described with reference to FIG. 4. The OIS processor 223 includes a filter 306, a phase compensator 307, an integrator 308, a multiplier 309, and a PID controller 310.

The filter 306 applies various kinds of filter processing to a signal received from the gyro sensor 224 The filter 306 includes a high pass filter (HPF), a low pass filter (LPF), a band pass filter (BPF), and/or the like, and blocks a predetermined low frequency component included in the signal by the HPF in order to block a drift component, for example.

The phase compensator 307 corrects a phase delay due to the OIS driver 221 or the like, in the signal received from the filter 306.

The integrator 308 integrates a signal received from the phase compensator 307 and indicating the angular velocity of shake (vibration), and generates a shake detection signal indicating the angle of the shake (vibration). Because the shake detection signal represents the amount of shake, it can be said that the shake detection signal represents a correction amount by which the shake is to be corrected. The shake detection signal from the integrator 308 is input to the PID controller 310 via the multiplier 309. The OIS processor 223 may use or add a filter configuration other than the above configuration, such as a notch filter for noise processing.

The multiplier 309 multiplies the shake detection signal received from the integrator 308 by, for example, a gain indicating the OIS ratio set by the lens controller 240, to calculate an OIS correction amount as a shake correction amount to be corrected by the OIS function. Each of the OIS ratios in the yaw direction and the pitch direction are set to “0” or more and “1” or less as a gain for the shake detection signal in the corresponding direction. The OIS ratio may be set for each of the directions.

The PID controller 310 performs PID control based on a difference between the OIS correction amount from the multiplier 309 and position information of the OIS lens 220 indicated by the signal from the position sensor 222, and generates a drive signal for the OIS driver 221. The OIS driver 221 drives the OIS lens 220 based on the drive signal.

In the present embodiment, for example, the lens controller 240 acquires an OIS error that is a deviation between the OIS correction amount in the PID control from the PID controller 310 and the position signal from the position sensor 222, in response to a request from the camera controller 140. The OIS error amount indicates a difference between the OIS correction amount and an amount of movement (i.e., displacement) of the OIS lens 220 indicated by the position information of the OIS lens 220 driven according to the OIS correction amount. The lens controller 240 transmits the OIS error to the camera controller 140 via the mounts 150,250. This error will be described later in detail.

### 1-3-2. BIS Processor

A configuration of the BIS processor 183 in the camera body 100 will be described with reference to FIG. 3. The BIS processor 183 includes a filter 406, a phase compensator 407, an integrator 408, a multiplier 409, and a PID controller 410.

The filter 406 applies various kinds of filter processing to a signal received from the gyro sensor 184. The filter 406 includes an HPF, an LPF, and/or a BPF, similarly to the filter 306 of the OIS processor 223, for example.

The phase compensator 407 corrects a phase delay due to the sensor driver 181 or the like to a signal received from the filter 406.

The integrator 408 integrates a signal received from the phase compensator 407 and indicating the angular velocity of shake (vibration), and generates a shake detection signal indicating the angle of the shake (vibration). Because the shake detection signal represents the amount of shake, it can be said that the shake detection signal represents a correction amount by which the shake is to be corrected. The shake detection signal from the integrator 408 is input to the PID controller 410 via the multiplier 409. The BIS processor 183 may use or add a filter configuration other than the above configuration, such as a notch filter for noise processing.

The multiplier 409 multiplies the shake detection signal received from the integrator 408 by, for example, a gain indicating the BIS ratio set by the camera controller 140, to calculate an BIS correction amount as a shake correction amount to be corrected by the BIS function. For example, the BIS ratio is separately set for a gain for the shake detection signal in the yaw direction and the pitch direction and a gain for the shake detection signal in the roll direction. In addition to or instead of this, gains may be set in the multiplier 409 separately for the shake detection signal in the yaw direction and the shake detection signal in the pitch direction.

The PID controller 410 generates a drive signal for shifting the image sensor 110 on the basis of an output from the position sensor 182 and an output from the multiplier 409, and outputs the drive signal to the sensor driver 181. The sensor driver 181 drives the image sensor 110 on the basis of the drive signal. For example, the camera controller 140 acquires, as an BIS error amount, the deviation input to the PID control from the PID controller 410. The BIS error amount indicates a difference between the BIS correction amount and the displacement indicated by the position information of the image sensor 110 driven according to the BIS correction amount by the image stabilization operation of the BIS function. The deviation of the PID control is calculated by the PID controller 410, for example, based on the BIS correction amount and the position signal from the position sensor 182.

### 1-3-3. EIS Processor

The EIS processor 143 will be described with reference to FIG. 3. The EIS processor 143 according to the present embodiment multiplies the shake detection signal input from the integrator 408 of the BIS processor 183, by a gain indicating the EIS ratio set by the camera controller 140, for example. For example, the EIS ratio is separately set for a gain for the shake detection signal in the yaw direction and the pitch direction and a gain for the shake detection signal in the roll direction. In addition to or instead of this, gains may be set separately for the shake detection signal in the yaw direction and the shake detection signal in the pitch direction.

The EIS processor 143 calculates a shake correction amount based on the shake detection signal. By then adding the BIS error acquired from the BIS processor 183 and the OIS error acquired by the lens controller 240 from the OIS processor 223, to the shake correction amount thus calculated, for example, the EIS processor 143 calculates an EIS correction amount (electronic correction amount), as a shake correction amount by the EIS function. Hereinafter, the OIS error and the BIS error will also be referred to as an “error amount”, collectively.

When the correction is performed for the use of the anamorphic lens 270, the EIS correction amount includes a shearing correction amount for correcting the shearing (or shearing distortion) introduced in correcting the image shake in the roll direction (rotational shake). In other words, the EIS processor 143 calculates a shearing correction amount for correctly deforming the subject image in the process of correcting the rotational deformation component with the anamorphic lens 270 mounted on the digital camera 1. The calculation of the shearing correction amount will be described later in detail.

For example, the EIS processor 143 may perform processing to crop an image in a narrowed area by the preset cropping amount from the entire image in the image data generated by the image sensor 110. The image data resultant of clipping may be subjected to various types of image processing for recording the result of image capturing, for example. For example, electronic zoom processing may be performed so that the cropped image cropping has the same size as the image before cropping.

When the EIS ratio includes a roll direction component greater than 0, the EIS processor 143 corrects the rotational shake based on the calculated EIS correction amount. When the anamorphic lens 270 is mounted on the digital camera 1, the EIS processor 143 corrects the shearing in the process of the rotational shake correction. When the EIS ratio includes a roll direction component greater than 0, the electronic correction performed by the EIS processor 143 includes the rotational shake correction and the shearing correction, such as that described above.

### 2. Operation

An operation of the digital camera 1 according to the present embodiment will be described.

2-1. Problem of Stabilizing with Use of Anamorphic Lens

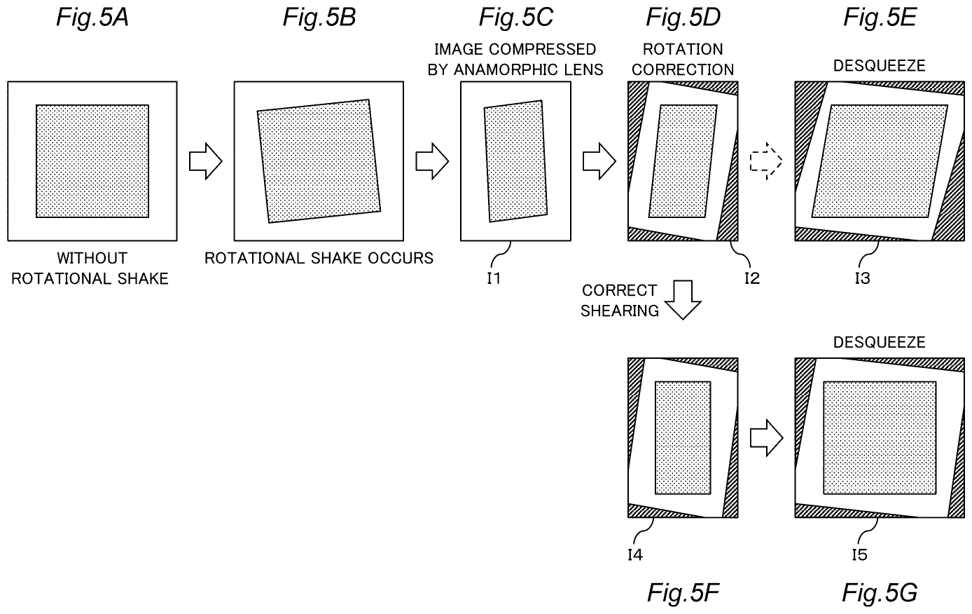

In describing the operation of the digital camera 1 according to the present embodiment, a problem in image stabilization using an anamorphic lens, which was found by the present inventor, will first be described with reference to FIGS. 5A to 5G.

FIGS. 5A to 5G show a schematic diagram for describing a comparative example of an operation for correcting a rotational shake in the digital camera on which an anamorphic lens is mounted. Such a digital camera records a subject image in a manner compressed (squeezed) by the anamorphic lens in the horizontal direction of an imaging surface, in the presence of a rotational shake, and reproduces or records the subject image by desqueezing the subject image after capturing the image.

FIGS. 5A and 5B are diagrams for describing a rotational shake, and schematically illustrate scenery perceived through the digital camera at the time of image capturing. FIG. 5A illustrates a scene at the time of shooting without rotational shake. FIG. 5B illustrates a scene at the time of shooting with rotational shake. FIG. 5C schematically illustrates an image I1 represented by image data generated by the image sensor in the presence of the rotational shake illustrated in FIG. 5B. The anamorphic lens forms the image of the subject on the imaging surface of the image sensor in a manner compressed in the horizontal direction, in the presence of a rotational shake. The quadrangle with dot hatching in FIG. 5C schematically illustrates such a subject image. The same applies to FIGS. 5D to 5G.

FIG. 5D illustrates an image 12 obtained by performing correction through image processing (electronic rotation correction) by which a rotational deformation is applied to the image (frame) I1 in FIG. 5C. In FIG. 5D, a portion hatched with lines indicates the area outside the angle of view of the image I1 before the rotational deformation is applied, and is an area without any information such as pixel values. The same applies to FIGS. 5E to 5G. The subject image in the image 12 has a parallelogram shape, as if the image is subjected to horizontal shearing image processing. In other words, the subject image in the image 12 has distortion (shearing) as if the image is subjected to the shearing image processing. Therefore, when the image 12 is subjected to desqueezing for stretching the image 12 in the horizontal direction, the desqueezed image 13 also has a shearing, as illustrated in FIG. 5E.

To prevent the desqueezed image from having such a shearing, it is effective to perform processing of correcting the shearing to the image 12 prior to subjecting the image to the desqueezing. FIG. 5F illustrates an image 14 obtained by correcting the shearing in the image 12 illustrated in FIG. 5D. By then desqueezing the image 14, a corrected image 15 similar to that without any rotational shake as illustrated in FIG. 5G can be achieved.

As described above, in the comparative example illustrated in FIG. 5, the rotation correction is performed on a frame-by-frame basis by electronic correction.

However, the inventor has found that, in a digital camera that performs desqueezing in accordance with an anamorphic lens, performing rotation correction on a frame-by-frame basis presents a new problem when correcting an image shake. That is, since the image processing is performed on a frame-by-frame basis for images captured by the digital camera, it is not possible to correct an image shake introduced during the exposure of a single frame.

In order to address this issue, the inventors conducted extensive research and consequently conceived the digital camera 1 according to the present embodiment. The digital camera 1 according to the present embodiment is capable of correcting an image shake that occurs during the exposure of a single frame by performing at least part of the rotation correction using optical correction that is executable at a period shorter than a frame period.

### 2-2. Outline of Operation According to Present Embodiment

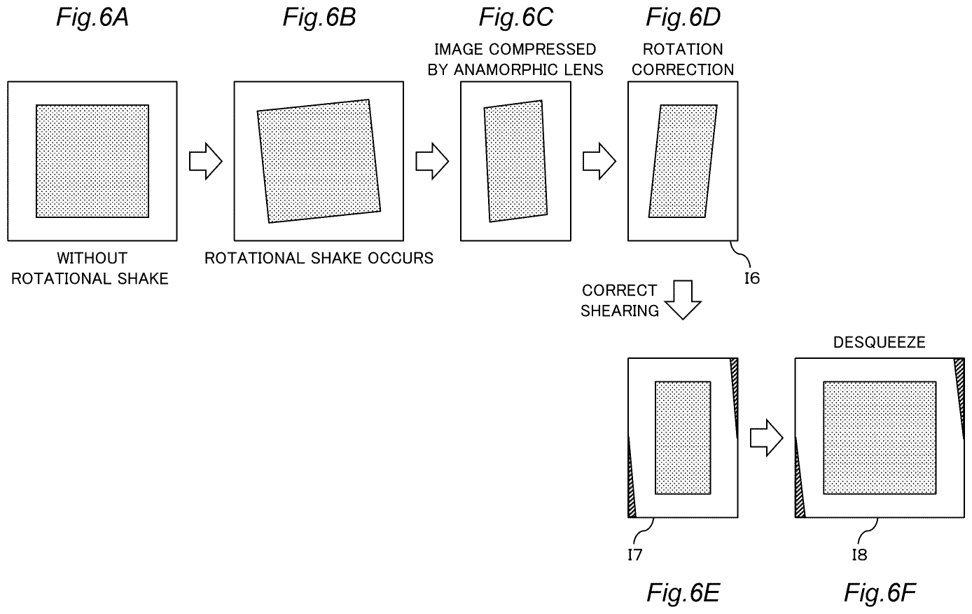

An outline of the operation of the digital camera 1 according to the present embodiment will be described with reference to FIG. 6. FIG. 6 is a schematic diagram for describing an operation for correcting a rotational shake in the digital camera 1. FIG. 6 illustrates an example in which the ratio of the optical correction occupying the correction amount for correcting the roll direction shake is 1, that is, an example in which the rotational shake is corrected with the optical correction without using the electronic correction.

FIGS. 6A and 6B schematically illustrate a scenery perceived through the digital camera 1 at the time of image capturing, in the same manner as FIGS. 5A and 5B. FIG. 6C schematically illustrates an optical image after passing through the anamorphic lens 270.

FIG. 6D schematically illustrates an image 16 represented by the image data generated by the image sensor 110 after the rotational shake is corrected by the optical correction. The rotational shake is corrected by rotating the image sensor 110 on the plane perpendicular to the optical axis of the optical system, and the subject image is then formed on the imaging surface of the image sensor 110 thus rotated. Because the image 16 in FIG. 6D is not an image obtained by rotationally deforming the captured image, the image 16 does not have any area having been outside of the angle of view (the hatched part in FIG. 5D) in the image before having been rotationally deformed as in FIG. 5D. As described above, the captured image according to the present embodiment has a larger area (more pixels) with information such as pixel values, compared with the captured image in the comparative example. Therefore, with the digital camera 1 according to the embodiment, it is possible to ensure a margin in the image, the margin being a margin for enabling the electronic correction including processing such as rotating and cutting the image data.

FIG. 6E illustrates an image 17 obtained by correcting the shearing in the image 16 illustrated in FIG. 6D. By desqueezing the image 17, a corrected image 18 similar to that without any rotational shake can be achieved, as illustrated in FIG. 6F.

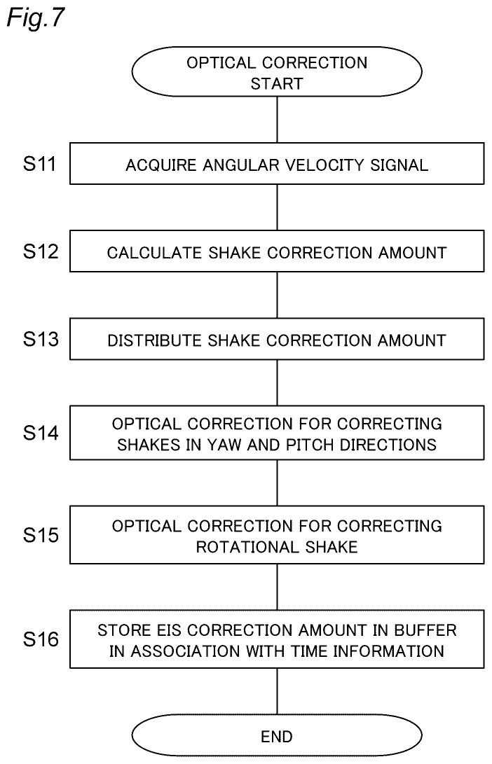

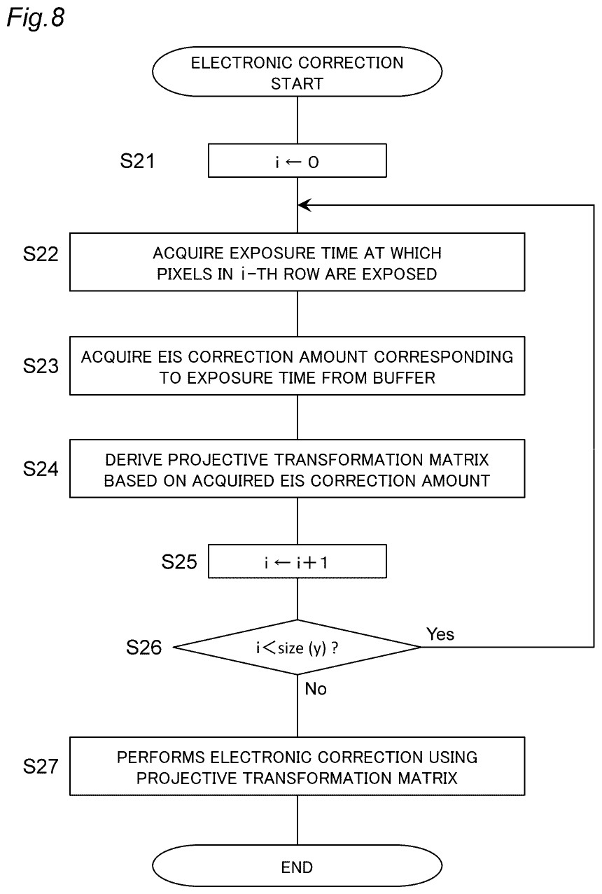

FIG. 7 is a flowchart illustrating the optical correction operation performed by the digital camera 1 according to the present embodiment. FIG. 8 is a flowchart illustrating the electronic correction operation performed by the digital camera 1 according to the embodiment.

Each process shown in the flowcharts of FIGS. 7 and 8 is executed, for example, in parallel with operations such as movie recording, by the camera controller 140, the OIS processing unit 223, and the BIS processing unit 183, when the interchangeable lens 200 is attached to the camera body 100.

The optical correction processing shown in FIG. 7 is repeated with a predetermined first period, for example. The first period is, for example, 1/10000 to 1/500 seconds (0.1 milliseconds to 2 milliseconds). The electronic correction processing shown in FIG. 8 is repeated with a predetermined second period, for example. The second period is, for example, a frame period, and is 1/60 to 1/30 seconds, for example. In the present embodiment, the first period is shorter than the second period.

### 2-3. Optical Correction Processing

The optical correction processing illustrated in FIG. 7 will be described. The BIS processor 183 acquires an angular velocity signal from the gyro sensor 184, and the OIS processor 223 acquires an angular velocity signal from gyro sensor 224 (S11).

The BIS processor 183 and the OIS processor 223 generate shake detection signals based on the respective angular velocity signals to calculate the respective shake correction amounts (S12).

The camera controller 140 acquires the shake correction amount from at least one of the OIS processor 223 and the BIS processor 183, and distributes the shake correction amount to an OIS correction amount, a BIS correction amount, and an EIS correction amount (S13). For example, the camera controller 140 calculates the OIS correction amount, the BIS correction amount, and the EIS correction amount based on the OIS ratio, the BIS ratio, and the EIS ratio, respectively. For example, the camera controller 140 may distribute the shake correction amount based on coefficients determined using information such as a focal length or based on frequency information.

In the present embodiment, the OIS correction amount and the BIS correction amount are collectively referred to as an “optical correction amount”. In the present embodiment, when there is a rotational shake, the optical correction amount in the roll direction is set to a value greater than 0. In other words, the roll-direction component of the BIS correction amount is greater than 0. By contrast, the roll-direction component of the EIS correction amount may be 0. Hereinafter, in the present embodiment, an example with the presence of a rotational shake will be described.

At least one of the OIS processor 223 and the BIS processor 183 performs the optical correction (S14) for correcting the shakes in the yaw direction and the pitch direction. The BIS processor 183 may perform the optical correction for correcting a rotational shake (S15).

In FIG. 7, for the convenience of explanation, step S14 and step S15 are shown separately, but these steps may be executed integrally. For example, the BIS processor 183 may transmit a drive signal for driving the image sensor 110 to the sensor driver 181, so as to shift the image sensor 110 in the yaw direction, the pitch direction, and the roll direction. The sensor driver 181 drives the image sensor 110 based on the drive signal. The OIS processor 223 may transmit a drive signal for driving the OIS lens 220 to shift in the yaw direction and the pitch direction, to the OIS driver 221, for example.

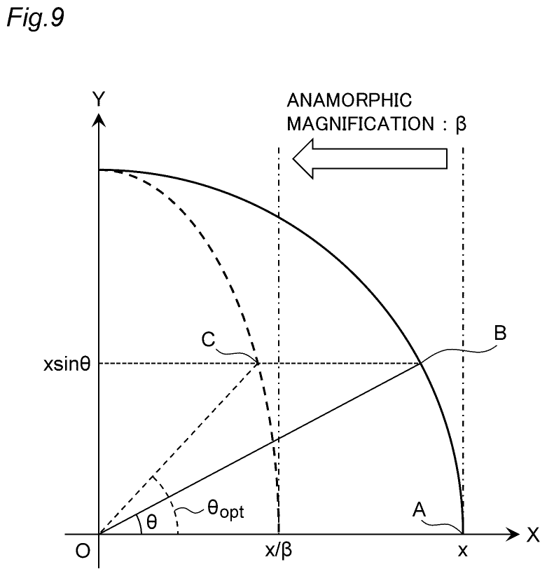

Described below with reference to FIG. 9 is an example of optical correction processing for correcting the rotational shake, in which the optical correction ratio in the shake correction amount in the roll direction is 1, that is, an example in which the rotational shake is corrected by the optical correction, without using the electronic correction.

As illustrated in FIG. 9, with a rotational shake by a rotation angle of θ in the roll direction with respect to the X axis, a point A at the coordinates (x, 0) moves to a point B (x cos θ, x sin θ), with respect to the origin at the optical center O. Assuming that the anamorphic lens 270 according to the present embodiment is a lens having an anamorphic magnification β that does not compress the subject image in the Y direction but compresses the subject image to 1/β in the X direction, the point B moves to the point C with reference to the image sensor 110. The coordinates of the point C are ((x/β)cos θ, x sin θ). Therefore, by performing a rotation correction by the angle θₒₚₜ expressed by following Formula (1), it is possible to correct the rotational shake with the anamorphic lens 270 mounted.

$${θ}_{opt} = {tan}^{- 1} ( β tan θ ) \qquad ( 1 )$$

Returning to FIG. 7, the camera controller 140 calculates the EIS correction amount based on the correction allocation set in step S13, and stores the EIS correction amount in a buffer in association with time information (S16). The time information includes, for example, the time at which the angular velocity signal is acquired in step S11. The frame buffer is, for example, a storage area provided in the RAM 141, the flash memory 142, or the like. The buffer only needs to be capable of storing therein the EIS correction amount and the time information, so that the buffer may be provided to another part of the digital camera 1, an external storage device, or the like.

### 2-4. Electronic Correction Processing

The electronic correction processing illustrated in FIG. 8 will be described. The camera controller 140 sets a variable i (i is an integer of 0 or more) to an initial value 0 (S21). In the present embodiment, the variable i corresponds to the number of rows (lines) in the image sensor 110. For example, the 0th row (i=0) represents the uppermost or lowermost sensor line of the image sensor 110.

The camera controller 140 acquires the exposure time at which pixels in the i-th row are exposed (S22), and acquires the EIS correction amount from the buffer, based on the acquired exposure time (S23). For example, if the first period of the optical correction processing is equal to the period in which the timing of exposure corresponding to one line arrives (line period, that is, the period in which steps S22 to S26 are repeated), the camera controller 140 acquires the EIS correction amount corresponding to the exposure time acquired in step S22 from the buffer.

Depending on the relationship between the first period and the line period, the processing described above may be adjusted. For example, if the first period is longer than the line period, the camera controller 140 searches the buffer for the time nearest to the exposure time acquired in step S22, and acquires the EIS correction amount associated with the searched time from the buffer. Alternatively, the camera controller 140 may acquire the EIS correction amounts associated with a plurality of respective time points in the neighborhood of the exposure time from the buffer, and determine the EIS correction amount to be used in the subsequent processing using a technique of interpolation (for example, linear interpolation) with the use of the acquired EIS correction amounts.

By contrast, when the first period is shorter than the line period, there may be a plurality of EIS correction amounts corresponding to one line period. In such a case, for example, the camera controller 140 determines a representative value of the EIS correction amounts (e.g., an average value of a plurality of EIS correction amounts) for each of the line periods.

The camera controller 140 obtains a projective transformation matrix based on the EIS correction amount acquired in step S23 (S24). The projective transformation matrix will be described later in detail.

The camera controller 140 then increments the variable i (S25), and repeats the processing of steps S22 to S26 until the variable i reaches a size (y) indicating the size of the image data or more (No in S26). The size (y) is, for example, the number of pixels of the image data in the vertical direction.

If the variable i is the size (y) or more (No in S26), the camera controller 140 performs the electronic correction using the projective transformation matrix (S27).

In the electronic correction processing, an image shake introduced during the exposure of one frame cannot be corrected, as described above. In order to alleviate the image shake introduced during the exposure of one frame, it is necessary to increase the shutter speed or to use the optical correction. As described above, the digital camera 1 according to the present embodiment combines the rotation correction that uses the optical correction, with the electronic correction. Specifically, by performing at least part of the rotation correction using the optical correction performed in the first period shorter than the second period, it is possible to correct the image shake introduced during the exposure of one frame.

Furthermore, the projective transformation matrix corresponding to the i-th row is obtained in the electronic correction in FIG. 8, which is executed in the second period, based on the correction amount associated with the time information, stored in step S16 during the optical correction in FIG. 7, which is executed in the first period (S22 to S24). When the first period is shorter than the second period, the amount of image deformation introduced in the electronic correction (e.g., the correction parameter corresponding to the projective transformation matrix) may change within one frame, without remaining uniform. For example, the amount of image deformation for the i-th row may be different from the amount of image deformation for the (i+1)th row. As described above, in the electronic correction according to the present embodiment, by using the information of the correction amount to be corrected in the optical correction, which is executed in the first period shorter than the second period, more detailed correction of the image shake can be achieved.

Furthermore, in the present embodiment, at least part of the rotation correction is performed using the optical correction illustrated in FIG. 7, so that it is easier to ensure a margin in the image for the electronic correction, which includes processing such as rotating and clipping of the image data, as described above.

In the example described above, the projective transformation matrix is derived on a line-by-line basis by obtaining the EIS correction amount from the buffer. For example, when a rolling shutter is used, the rolling shutter distortion can be reduced by using the projective transformation matrix corresponding to every single one of the entire lines. However, the present embodiment is not limited to the mode in which the projective transformation matrix is calculated for every one of the entire lines. For example, the camera controller 140 may obtain projective transformation matrices for a smaller number of a lines than the number of vertical pixels, with a predetermined interval therebetween, for example. In such a case, the means for correcting the decimated lines may be determined using an approach of interpolation (for example, linear interpolation) that uses information in the lines for which the projective transformation matrices have been obtained. Note that, even by decimating the lines for which the projective transformation matrices are obtained, it is possible to reduce the rolling shutter distortion (or rolling shutter phenomenon) while reducing the processing load by using the projective transformation matrix corresponding to every one of such a plurality of lines.

Furthermore, the present embodiment is not limited to the example in which the electronic correction is performed using the projective transformation matrix obtained correspondingly to each line. For example, the camera controller 140 may obtain one representative projective transformation matrix per frame, and perform electronic correction using the representative projective transformation matrix. For example, the camera controller 140 obtains a representative projective transformation matrix based on the projective transformation matrices corresponding to a plurality of respective lines. The camera controller 140 may also correct the entire frame (all of the lines) using a projective transformation matrix corresponding to a specific one of the lines (for example, the line located at the center in the vertical direction) included in the frame. In this case, it is not necessary to obtain a large number of projective transformation matrices corresponding to a plurality of respective lines, so that it is possible to reduce the amount of calculation performed by the camera controller 140.

### 2-4-1. Projective Transformation Operation

The projective transformation matrix used in the electronic correction processing will now be described. The camera controller 140 applies geometric image deformation processing to the image data using the technique of projective transformation.

In general, a rotation matrix R representing a rotation in the roll direction is expressed as following Formula (2).

$$R = [ \begin{matrix}cos θ & - sin θ & 0 \\ sin θ & cos θ & 0 \\ 0 & 0 & 1\end{matrix} ] \qquad ( 2 )$$

A projective transformation matrix Hₒₚₜ representing a roll-direction rotation (rotation angle θₒₚₜ) executed in the optical correction processing in FIG. 7 is expressed as following Formula (3).

$${H}_{opt} = [ \begin{matrix}cos {θ}_{opt} & - sin {θ}_{opt} & 0 \\ sin {θ}_{opt} & cos {θ}_{opt} & 0 \\ 0 & 0 & 1\end{matrix} ] \qquad ( 3 )$$

In the electronic correction processing, correction processing is performed to correct remaining image deformation (the rotational shake and the shearing). A projective transformation matrix H_{cis} representing image deformation executed in the electronic correction processing is expressed as following Formula (4).

$${H}_{eis} = {{[ \begin{matrix}\frac{f}{β} & 0 & 0 \\ 0 & f & 0 \\ 0 & 0 & 1\end{matrix} ] [ \begin{matrix}cos θ & - sin θ & 0 \\ sin θ & cos θ & 0 \\ 0 & 0 & 1\end{matrix} ]}^{- 1} [ \begin{matrix}\frac{f}{β} & 0 & 0 \\ 0 & f & 0 \\ 0 & 0 & 1\end{matrix} ]}^{- 1} {H}_{opt}^{- 1} \qquad ( 4 )$$

In Formula (4), θ represents the rotation angle of the rotational shake in the roll direction. When the rotational shake is entirely corrected by the optical correction, the relationship between θₒₚₜ and θ is expressed as Formula (1) above. β is an anamorphic magnification.

As indicated in Formula (4), the projective transformation matrix H_{cis} representing the electronic correction processing, which is executed by the EIS processor 143 of the camera controller 140, includes the projective transformation matrix Hₒₚₜ representing the optical correction processing. As described above with reference to FIGS. 7 and 8, the first period of the optical correction processing and the second period of the electronic correction processing are different, but the digital camera 1 performs the entire image shake correction by causing the optical correction processing and the electronic correction processing to cooperate with each other, as indicated in Formula (4).

### 3. Summary

The digital camera 1 according to the present embodiment includes the image sensor 110, the optical image stabilizer including the BIS processor 183 (first image shake correction unit), the EIS processor 143 (electronic image stabilizer), and the camera controller 140. The optical image stabilizer may include the OIS processor 223 (second image shake correction unit). In the present embodiment, the OIS processor 223, the BIS processor 183, and the camera controller 140 are examples of a controller that controls image shake correction performed by the optical image stabilizer and the EIS processor 143. The image sensor 110 captures a subject image formed via the optical system to generate image data. The OIS processor 223 performs image stabilization by moving OIS lens 220 included in the optical system on a plane perpendicular to the optical axis of the optical system including OIS lens 220 (correction lens). The BIS processor 183 performs image stabilization by moving the image sensor 110 within a plane perpendicular to the optical axis. The EIS processor 143 performs an image stabilization by applying image processing to the image data. The optical system compresses the subject image more in the X direction (first direction) orthogonal to the optical axis than in the Y direction (second direction) orthogonal to the optical axis. The optical image stabilizer corrects a rotational shake in the rotational direction about the optical axis (S15). The EIS processor 143 corrects a shearing resulting from compression of the subject image by the optical system, in a state where the rotational shake is corrected by the optical image stabilizer (S27).

In the present embodiment, the optical system includes the anamorphic lens 270.

With the digital camera 1 described above, an image shake with the use of the anamorphic lens 270 can be corrected appropriately, e.g., more accurately, by correcting the rotational shake using the optical image stabilizer.

In the present embodiment, the optical image stabilizer may correct at least part of the rotational shake, and the EIS processor 143 may correct the shearing corresponding to the rotational shake, without rotating the subject image by the amount of the rotational shake corrected by the optical image stabilizer. With this configuration, too, an image shake can be corrected appropriately.

In the present embodiment, the EIS processor 143 may correct a shearing, without correcting a rotational shake. With this configuration, the shearing of the subject image with the use of the anamorphic lens 270 can be corrected appropriately, after the rotational shake is corrected by the optical image stabilizer.

In the present embodiment, the EIS processor 143 performs image processing based on a result having a rotational shake corrected by the optical image stabilizer to correct the shearing (S27). The electronic correction processing is not capable of correcting the image shake introduced during the exposure of one frame. Merely by performing the electronic correction processing, the image shake introduced during the exposure remains as blur, without being corrected. With the configuration according to the embodiment described above, the optical image stabilizer and the EIS processor 143 cooperate with each other, so that it is possible to reduce the amount of rotational shake to be corrected by the EIS processor 143, by the amount corrected by the optical image stabilizer. Therefore, with this configuration, it is possible to correct a shearing while alleviating the effect of the image shake introduced during the exposure of one frame, the image shake remaining in the image without being corrected.

In the present embodiment, the optical image stabilizer corrects a rotational shake in a first period, and the EIS processor 143 corrects a shearing by performing image processing in a second period. The first period is shorter than the second period. In this manner, an image shake introduced during the exposure of one frame can be corrected. In this case, the camera controller 140 generates image data in units of one frame by causing the image sensor 110 to operate with a predetermined frame period, and the EIS processor 143 performs image processing by changing the correction amount for correcting the shearing within the range of the frame period, on the basis of the result of the rotational shake correction of the optical image stabilizer (S22 to S27). By using the information of the correction amount corrected in the optical correction executed in the first period shorter than the second period, more detailed correction of the image shake can be achieved.

The digital camera 1 according to the present embodiment further includes the body mount 150, which is an example of a connector to which the interchangeable lens 200 is connected removably, and the optical system is included in the interchangeable lens 200.

### Second Embodiment

### 1. Overview

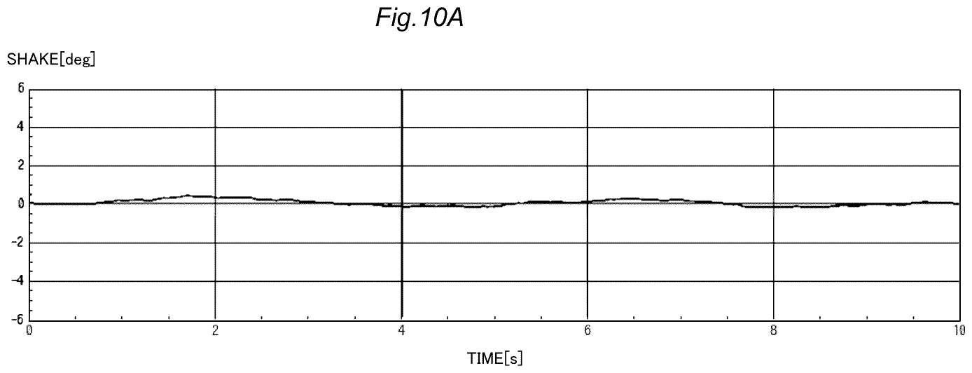

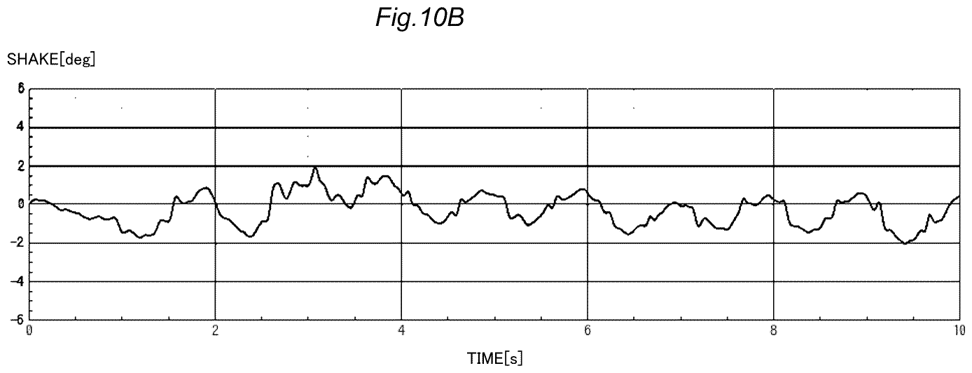

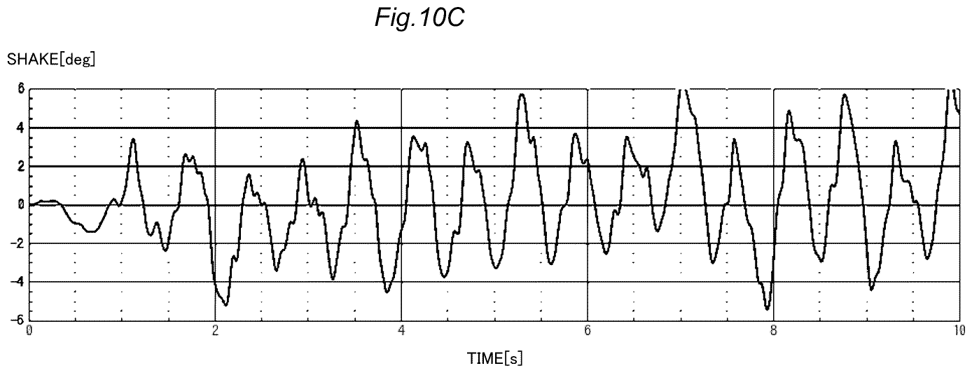

When performing image capture while walking (hereinafter referred to as a walking shot) or image capture while running (hereinafter referred to as a running shot) using a digital camera, the digital camera generally shakes significantly. FIG. 10A is a graph illustrating an example of a temporal change in the rotational shake in the roll direction, when a stationary photographer captures an image. FIGS. 10B and 10C are graphs illustrating examples of temporal changes in the rotational shake in the roll direction during a walking shot and a running shot, respectively. For example, while the magnitude of shake that occurs during stationary shooting is approximately ±0.5°, in recent years, shake correction performance of approximately ±1° to 3° for walking shots and approximately and approximately ±7° for running shots has sometimes been required.

In conventional digital cameras that cannot sufficiently correct significant shakes occurring during walking shots or running shots, the influence of shake in the image is greater than that of blur (smearing), and thus the user is rarely bothered by the blur even if it exists in the image. By contrast, when the significant shake is corrected either partly or entirely using the electronic correction, although the influence of the shake in the image becomes smaller, the blur becomes noticeable to the user, and the effect of the blur becomes more conspicuous.

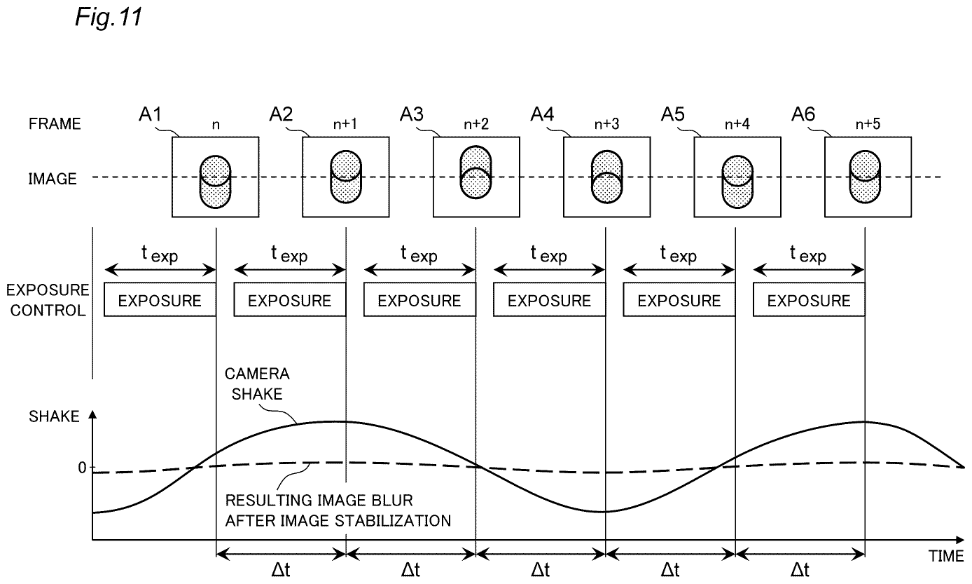

FIG. 11 is a schematic diagram for describing how blur becomes apparent as described above. In the graph in the bottom of FIG. 11, an example of shake over the lapse of time is indicated by the solid line. The broken line in the graph in FIG. 11 schematically indicates the amount of image shake (blur) in images A1 to A6 represented by the image data resultant of the electronic correction. The images A1 to A6 are images represented by the image data corresponding to respective frames (n-th to (n+5)-th frames), and Δt indicated on the time axis of the graph in FIG. 11 represents a frame period. In FIG. 11, tₑₓₚ denotes the exposure time corresponding to each of the frames.

The images A1 to A6 exemplify images represented by image data obtained by capturing a subject image having a circular shape on the image plane. The images A1 to A6 in FIG. 11 illustrate subject images including blur. With the shake corrected by the electronic correction, the image shake introduced during the exposure of one frame appears as blur. With the shake corrected by the electronic correction, as indicated by the broken line in the graph of FIG. 11, the effect of movement of the subject image between the frames due to the shake decreases, but the blur is not reduced, so that the effect of the blur with respect to the magnitude of the shake increases, as compared with that before the correction.

For example, blur can be reduced by shortening the exposure time by controlling the shutter speed. However, if the exposure time is shortened, the positions of the subject do not connect smoothly between frames, and the motion of the subject may appear to be discontinuous in the video.

In order to address this issue, the inventor has intensively studied and come up with an idea of the digital camera 1 according to the present embodiment. The digital camera 1 according to the present embodiment can reduce the effect of blur in the image by performing at least part of the rotation correction in the optical correction. It is particularly useful to perform at least part of the rotation correction using the optical correction when the digital camera 1 can correct a rotational shake having a magnitude of 1° or more (rotational shake of 1° or more or rotational shake of −1° or less). This is because the effect of blur becomes apparent once such rotational shake is corrected.

With regard to the optical correction, if the optical component (image sensor) for correcting a rotation is rotatable by φ₁° about the optical axis with respect to the casing of the digital camera 1, it can be said that the optical correction is capable of correcting a rotational shake of φ₁°. In the electronic correction, if the image represented by the image data captured by the image sensor is rotatable by φ₂° about the optical axis, it can be said that the electronic correction is capable of correcting a rotational shake of φ₂°. The digital camera 1 being capable of correcting a rotational shake of a magnitude of 1° or more means that the absolute value of (φ₁+φ₂) is 1 or more.

In particular, the effect of blur becomes apparent when a rotational shake of a magnitude of 1° or more is corrected using the electronic correction. The digital camera 1 according to the present embodiment can reduce the effect of blur in the image by optically correcting the rotation at least partially when the magnitude of an angle φ₂ that is electronically correctable in units of one frame is 1° or more.

### 2. Operations

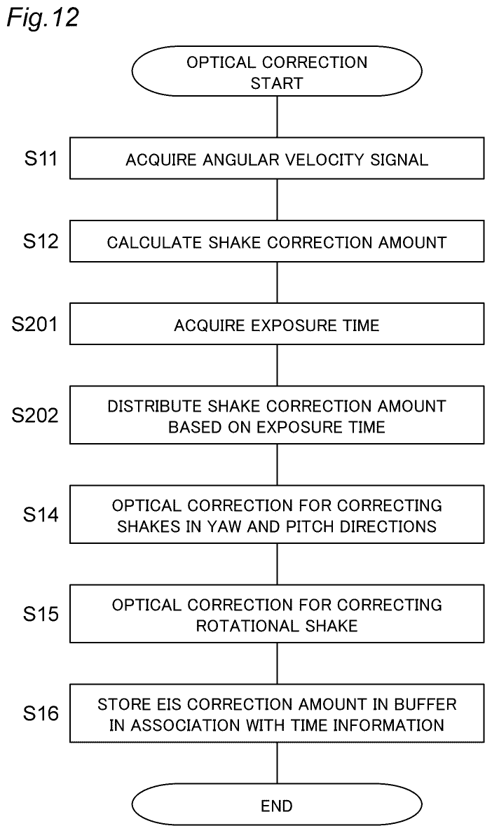

FIG. 12 is a flowchart illustrating the optical correction processing performed by the digital camera 1 in the present embodiment. As compared with the optical correction processing according to the first embodiment illustrated in FIG. 7, the optical correction processing illustrated in FIG. 12 includes step S201 of acquiring the exposure time after steps S11 and S12, and includes step S202, instead of the process S13 of distributing the shake correction amount.

In step S201, the camera controller 140 acquires exposure time. The exposure time may be manually set by the user on the menu screen or by operating a dial, or may be automatically set by the camera controller 140 on the basis of the brightness of the subject. As an example, the camera controller 140 sets the exposure time on the basis of the brightness of the subject. Alternatively, the camera controller 140 may acquire the exposure time manually set by the user. In these cases, the exposure time may change during a video shooting.

Step S201 does not necessarily need to be executed after step S12 as in FIG. 12, and may be executed between steps S11 and S12 or before step S11, for example. As an example, the camera controller 140 may acquire the exposure time at the same time as the frame rate is set, or immediately thereafter. The exposure time may be set on the basis of the frame rate. For example, the exposure time may be set to ½ of the frame period.

The camera controller 140 distributes the shake correction amount to the optical correction amount and the EIS correction amount, based on the exposure time acquired in step S201 (S202). For example, the camera controller 140 changes the ratio of the optical correction amount and the ratio of the EIS correction amount, on the basis of the exposure time.

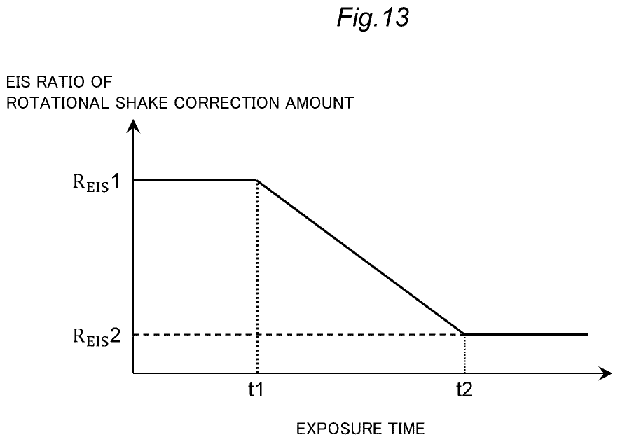

FIG. 13 is a graph illustrating an example of the relationship between the exposure time and the EIS ratio that is applied to the rotational shake correction amount in the digital camera 1 according to the present embodiment. In the graph in FIG. 13, the horizontal axis represents the exposure time (shutter speed), and the vertical axis represents the EIS ratio applied to the rotational shake correction amount. The EIS ratio of the rotational shake correction amount represents the ratio of the amount of EIS correction for the rotational shake to the sum of the amounts of optical correction and EIS correction for the rotational shake ((amount of EIS correction for the rotational shake)/(amount of optical correction for the rotational shake+amount of EIS correction for the rotational shake)).

In the example illustrated in FIG. 13, when the exposure time is t1 (e.g., ( 1/250) seconds), the camera controller 140 sets R_{EIS}1 as the EIS ratio of the rotational shake correction amount; and, when the exposure time is t2 (for example, ( 1/30) seconds), the camera controller 140 sets R_{EIS}2 as the EIS ratio of the rotational shake correction amount. R_{EIS}1 is higher than R_{EIS}2, and 1≥R_{EIS}1>R_{EIS}2≥0. For example, R_{EIS}1=0.5 and R_{EIS}2=0.1. It is also possible for the camera controller 140 to, denoting the angle of the rotational shake correctable by the optical correction processing as a first angle, and denoting an angle of the rotational shake correctable by the electronic correction processing as a second angle, set R_{EIS} 1 to the ratio of the second angle with respect to the sum of the first angle and the second angle.

As illustrated in FIG. 13, for the time between the exposure time t1 and t2, the camera controller 140 may set a smaller EIS ratio of the rotational shake correction amount for a longer exposure time.

In FIG. 13, R_{EIS}2 may be 0. In such a case, when the exposure time is longer than t2, the digital camera 1 performs the correction of the rotational shake only by the optical correction. That is, in a case where the exposure time is longer than a predetermined time, the camera controller 140 may correct the rotational shake only with the optical correction; and when the exposure time is the predetermined time or less, the camera controller 140 may determine the ratios of the optical correction amount and the EIS correction amount in the rotational shake correction amount, on the basis of the exposure time. When the exposure time is longer than the predetermined time, the EIS processor 143 only corrects the shearing, without correcting the rotational shake.

While the effect of blur becomes apparent when the exposure time is relatively long, the digital camera 1 according to the present embodiment can reduce the effect of the blur in the image by performing at least part of the rotation correction using the optical correction.

For example, a table specifying the relationship between the exposure time and the EIS ratio of the rotational shake correction amount, as indicated in FIG. 13, is stored in advance in a recording medium such as the flash memory 142, and the camera controller 140 extracts the EIS ratio corresponding to a set exposure time from the table. The camera controller 140 then determines the optical correction amount and the EIS correction amount in such a manner that the extracted EIS ratio is achieved, for example.

### 3. Summary

As described above, in the digital camera 1 according to the present embodiment, the camera controller 140 may change a ratio of the electronic correction amount allocated to the EIS processor 143 (electronic image stabilizer) to a sum of the optical correction amount allocated to the optical image stabilizer, depending on the exposure time. As a result, the effect of blur in the image can be reduced.

In the digital camera 1 according to the present embodiment, the camera controller 140 may decrease, as the exposure time becomes longer, the ratio of the electronic correction amount to the sum of the optical correction amount and the electronic correction amount. As a result, the effect of blur in the image can be further reduced.

The digital camera 1 according to the present embodiment may be enabled to correct a rotational shake having a magnitude of 1° or more. While the effect of blur becomes apparent when the rotational shake of a magnitude of 1° or more is corrected, the digital camera 1 according to the present embodiment can reduce the effect of blur in the image by performing at least part of the rotation correction by using the optical correction.

### Other Embodiments

The first and the second embodiments are described above as some examples of the technology according to the present disclosure. However, the technology according to the present disclosure is not limited thereto, and may also be applied to embodiments including changes, replacements, additions, omissions, and the like made as appropriate. In addition, it is also possible to combine the elements described in the embodiments to form a new embodiment. Therefore, modifications as other embodiments will be described below.

### (First Modification)

In the example described in the embodiment, the interchangeable lens 200 including the anamorphic lens 270 is mounted on the camera body 100. However, the digital camera 1 according to the present disclosure may use an operation for the interchangeable lens 200 including the anamorphic lens 270 and an operation for the interchangeable lens 200 not including anamorphic lens 270, selectively.

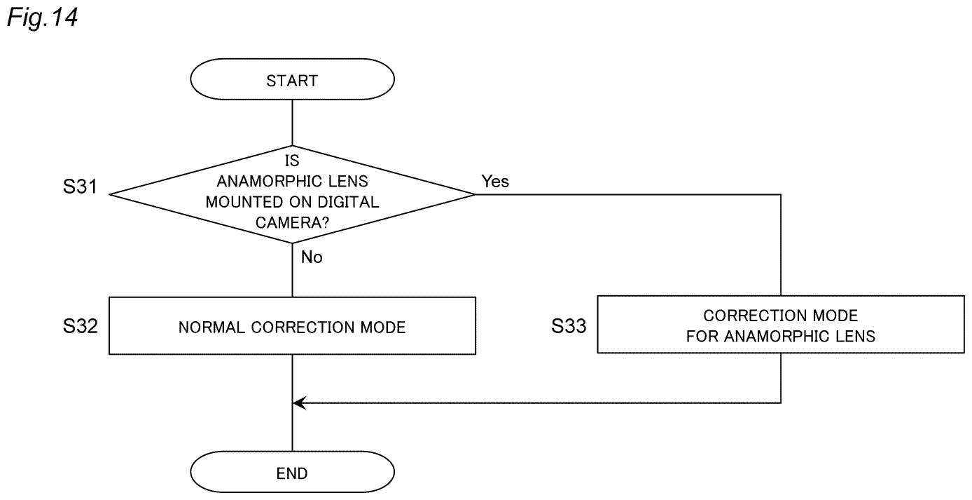

FIG. 14 is a flowchart illustrating an operation of the digital camera 1 according to the first modification. The sequence illustrated in FIG. 14 is executed every time the interchangeable lens is mounted on the body mount 150 of the camera body 100, for example.

In FIG. 14, the camera controller 140 determines whether the anamorphic lens 270 is mounted on the digital camera 1 (S31).

A signal for this determination is generated by the lens controller 240, for example. As an example, the lens controller 240 may automatically transmit an anamorphic lens detection signal to the camera controller 140 via the lens mount 250 and the body mount 150 when the interchangeable lens 200 including the anamorphic lens 270 is mounted on the body mount 150. The camera controller 140 may also ask the lens controller 240 whether the interchangeable lens 200 includes the anamorphic lens 270, and the lens controller 240 may transmit the anamorphic lens detection signal to the camera controller 140 as a response. The camera controller 140 may be configured to acquire information indicating the anamorphic magnification β automatically from the interchangeable lens 200.

If the anamorphic lens 270 is not mounted on the digital camera 1 (No in S31), the camera controller 140 operates in a normal correction mode (that is, in a mode not for an anamorphic lens) (S32). In the normal correction mode, the camera controller 140 performs image stabilization by at least one of the OIS function, the BIS function, and the EIS function. It is also possible to execute a known camera-shake stabilizing function in the normal correction mode.

When the anamorphic lens 270 is mounted on the digital camera 1 (Yes in S31), the camera controller 140 operates in the correction mode for the anamorphic lens 270 (hereinafter, referred to as an “anamorphic lens mode”) (S33). In the anamorphic lens mode, the camera controller 140 executes the optical correction processing illustrated in FIG. 7 and the electronic correction processing illustrated in FIG. 8.

It is not necessary to automatically make the determination as to whether the anamorphic lens 270 is mounted on the digital camera 1, and for example, the anamorphic lens mode may be set manually by the user from a menu screen. It is also possible to permit a user to enter information of the anamorphic magnification β. For example, it is possible to omit step S31 for performing the lens determination processing, and the user may set an appropriate value (e.g., 2) to β when the anamorphic lens 270 is to be used, and β=1 may be set when the anamorphic lens 270 is not used.

As described above, in the digital camera 1 according to the first modification, in a case where the interchangeable lens connected to the body mount 150 does not include the anamorphic lens 270, the camera controller 140 causes the optical image stabilizer to correct a rotational shake, without causing the EIS processor 143 to correct the shearing. By contrast, in a case where the interchangeable lens connected to the body mount 150 includes the anamorphic lens 270, the camera controller 140 causes the optical image stabilizer to correct the rotational shake, and causes the EIS processor 143 to correct the shearing.

### (Second Modification)

In the example described in the embodiments, the anamorphic lens 270 is included in the optical system of the interchangeable lens 200, but it is also possible for the anamorphic lens not to be included in the interchangeable lens 200. For example, without including an anamorphic lens in the interchangeable lens 200, an anamorphic lens separate from the interchangeable lens 200 may be mounted on the interchangeable lens 200 or on the camera body 100. Such a configuration also is an example of a configuration in which the optical system includes an anamorphic lens.

### (Third Modification)

In the example described in the embodiments, when there is a rotational shake of a rotation angle θ in the roll direction with reference to the X axis (horizontal direction), the rotational shake is optically corrected by θₒₚₜ corresponding to θ (see FIG. 9). Unlike this example, the optical correction of a rotational shake in the roll direction may use the Y axis (vertical direction) as a reference. For example, a user may manually set as to which of the horizontal direction and the vertical direction is to be used as the reference in correcting the rotational shake, on the menu screen.

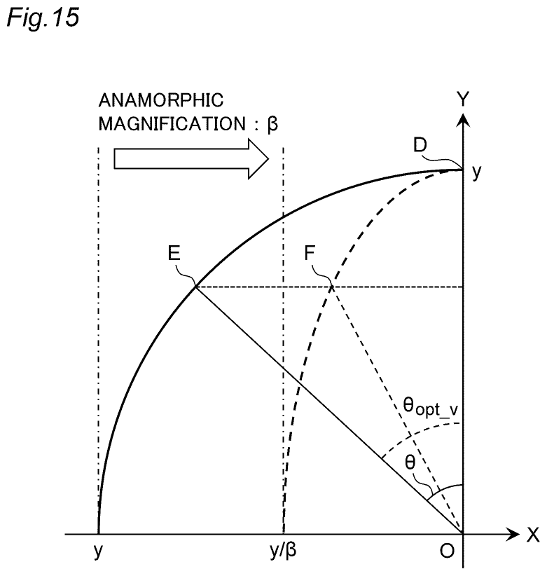

As illustrated in FIG. 15, with a rotational shake by a rotation angle θ in the roll direction with respect to the Y axis, a point D at the coordinates (0, y) moves to a point E (y sin θ, y cos θ), with respect to the origin at the optical center O. With the compression of the anamorphic lens 270 having the anamorphic magnification β, the point E moves to a point F ((y/β) sin θ, y cos θ), with reference to the image sensor 110. Therefore, by performing the rotation correction by the angle θ_{opt_v} expressed by following Formula (5), it is possible to correct the rotational shake while the anamorphic lens 270 is mounted.

$${θ}_{opt\_v} = {tan}^{- 1} ( ( 1 / β ) tan θ ) \qquad ( 5 )$$

### (Fourth Modification)

In the example described in the embodiments, the first period is shorter than the second period, but the idea of the present disclosure is also applicable to a configuration in which the first period is equal to the second period. For example, in the digital camera 1 that performs desqueezing correspondingly to the anamorphic lens, by correcting the rotation at least partly using the optical correction, it is possible to reduce the load of the camera controller 140 that performs other correction using the electronic correction.

### (Fifth Modification)

In the example described in the embodiments, the interchangeable lens digital camera is used as an example of the imaging apparatus, but the imaging apparatus according to the present disclosure may be a digital camera with a built-in lens instead of the interchangeable lens digital camera. Furthermore, the imaging apparatus according to the present disclosure is not limited to a digital camera, and may be an electronic device such as a movie camera, a mobile phone with a camera, a smartphone, or a tablet terminal.

### (Sixth Modification)

In the second embodiment, it has been described how blur becomes apparent. Even with the same shake of the camera body 100, the magnitude of the image shake differs when the lens has a different focal length. Therefore, the sufficiency of the correction performance of the digital camera 1 is also dependent on the focal length. For example, when the focal length is longer, image shakes in the yaw and pitch directions on the image plane increase, so that the effect of blur is likely to become more apparent. In order to suppress blur, it is conceivable to increase the amount of optical correction in the yaw direction and the pitch direction when the focal length is longer. For this purpose, it is useful to reduce the amount of optical correction in the roll direction when the focal length is longer. Conversely, the amount of optical correction in the roll direction may be increased when the focal length is shorter.

Therefore, the digital camera 1 may use only the optical correction in the correction of a rotational shake when the focal length is shorter than a predetermined threshold. In other words, the camera controller 140 may use only the optical correction in correcting the rotational shake when the focal length is shorter than the predetermined threshold; and, when the focal length is the predetermined threshold or more, the camera controller 140 may determine the ratios of the optical correction amount and the EIS correction amount on the basis of the focal length.

### (Seventh Modification)

Furthermore, even with the same shake of the camera body 100, the magnitude of the image shake differs when the anamorphic magnification β of the anamorphic lens 270 is different. When the image shake is significant, the effect of the blur is likely to be more apparent. Therefore, the digital camera 1 may distribute the shake correction amount to the optical correction amount and the EIS correction amount based on the anamorphic magnification β.

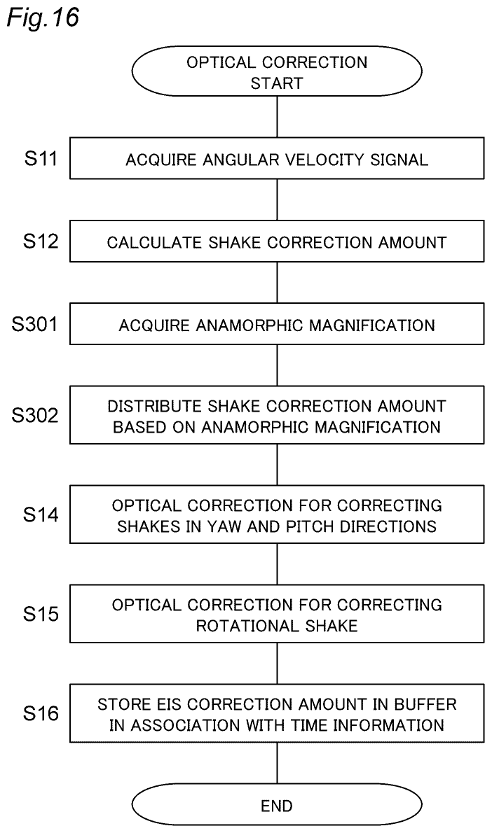

FIG. 16 is a flowchart for describing a process of distributing the shake correction amount in this modification. As compared with the optical correction processing according to the second embodiment illustrated in FIG. 12, the optical correction processing in FIG. 16 includes steps S301 and S302, instead of steps S201 and S202.

In step S301, the camera controller 140 acquires information indicating the anamorphic magnification β of the anamorphic lens 270. For example, when the interchangeable lens 200 including the anamorphic lens 270 is mounted on the body mount 150, the lens controller 240 may transmit information indicating the anamorphic magnification β to the camera controller 140. The camera controller 140 may also acquire the information indicating the anamorphic magnification β automatically from the interchangeable lens 200. The information indicating the anamorphic magnification β may also be entered manually by the user on the menu screen or by operating a dial.

The camera controller 140 distributes the shake correction amount to the optical correction amount and the EIS correction amount, based on the anamorphic magnification β acquired in step S301 (S302). For example, the camera controller 140 changes the ratios of the optical correction amount and the EIS correction amount, on the basis of the anamorphic magnification β. Because the lateral focal length becomes shorter when the anamorphic magnification β becomes higher, the camera controller 140 reduces the EIS ratio when the anamorphic magnification β is higher, for example.

As a result, the effect of blur in the image can be reduced.

### Example of Aspects

Hereinafter, various aspects according to the present disclosure will be listed.

Aspect 1 according to the present disclosure provides an imaging apparatus including:
an image sensor that captures a subject image formed via an optical system to generate image data;
an optical image stabilizer that performs image stabilization by moving the image sensor within a plane perpendicular to an optical axis of the optical system; and
an electronic image stabilizer that performs image stabilization by applying image processing to the image data; and
a controller that controls the optical image stabilizer and the electronic image stabilizer, wherein
the optical system compresses the subject image more in a first direction orthogonal to the optical axis than in a second direction orthogonal to the optical axis,
the optical image stabilizer corrects a rotational shake in a rotational direction about the optical axis, and
the electronic image stabilizer corrects a shearing resulting from compression of the subject image by the optical system in a state where the rotational shake is corrected by the optical image stabilizer.

Aspect 2 provides the imaging apparatus according to Aspect 1, wherein the controller changes a ratio of an electronic correction amount of the electronic image stabilizer to a sum of an optical correction amount of the optical image stabilizer and the electronic correction amount, depending on an exposure time in image capturing performed by the image sensor.

Aspect 3 provides the imaging apparatus according to Aspect 2, wherein the controller decreases, as the exposure time becomes longer, the ratio of the electronic correction amount to the sum of the optical correction amount and the electronic correction amount.

Aspect 4 provides the imaging apparatus according to any one of Aspects 1 to 3, wherein the imaging apparatus corrects a rotational shake having a magnitude of 1° or more.

Aspect 5 provides the imaging apparatus according to any one of Aspects 1 to 4, wherein
the optical image stabilizer corrects at least a part of the rotational shake, and
the electronic image stabilizer corrects the shearing associated with the rotational shake without rotating the subject image for a portion of the rotational shake corrected by the optical image stabilizer.

Aspect 6 provides the imaging apparatus according to any one of Aspects 1 to 4, wherein the electronic image stabilizer corrects the shearing without correcting the rotational shake.

Aspect 7 provides the imaging apparatus according to any one of Aspects 1 to 6, wherein the optical system includes an anamorphic lens.

Aspect 8 provides the imaging apparatus according to Aspect 7, wherein
the optical image stabilizer corrects the rotational shake by rotating the image sensor by an angle θopt represented by formula (1) in the rotational direction,

$${θ}_{opt} = {tan}^{- 1} ( β tan θ ) , \qquad ( 1 )$$

wherein θ is a rotation angle of the rotational shake, and β is an anamorphic magnification of the anamorphic lens.

Aspect 9 provides the imaging apparatus according to any one of Aspects 1 to 8, wherein the electronic image stabilizer corrects the shearing by performing the image processing based on a result of a rotational shake correction of the optical image stabilizer.

Aspect 10 provides the imaging apparatus according to any one of Aspects 1 to 9, wherein
the optical image stabilizer corrects the rotational shake in a first period, and
the electronic image stabilizer corrects the shearing by performing the image processing in a second period, and
the first period is shorter than the second period.

Aspect 11 provides the imaging apparatus according to Aspect 10, wherein the second period is a frame period in which the image sensor generates image data for each frame, and
the electronic image stabilizer performs the image processing by changing a correction amount for correcting the shearing within a range of the frame period, based on a result of the rotational shake correction of the optical image stabilizer.

Aspect 12 provides the imaging apparatus according to any one of Aspects 1 to 11, further including a connector that removably connects an interchangeable lens, wherein the optical system is included in the interchangeable lens.

Aspect 13 provides the imaging apparatus according to Aspect 12, wherein the controller is configured:
to cause the optical image stabilizer to correct the rotational shake without causing the electronic image stabilizer to correct the shearing when the interchangeable lens connected to the connector does not include the optical system; and
to cause the optical image stabilizer to correct the rotational shake, and to cause the electronic image stabilizer to correct the shearing, when the interchangeable lens connected to the connector includes the optical system.

The concept of the present disclosure can be applied to an electronic device (e.g., imaging apparatuses such as digital cameras, camcorders, mobile phones, smartphones, and the like) having an image shooting function provided with an image stabilizing function.

What is claimed is:

1. An imaging apparatus comprising:
an image sensor that captures a subject image formed via an optical system to generate image data;
an optical image stabilizer that performs image stabilization by moving the image sensor within a plane perpendicular to an optical axis of the optical system; and
an electronic image stabilizer that performs image stabilization by applying image processing to the image data; and
a controller that controls the optical image stabilizer and the electronic image stabilizer, wherein
the optical system compresses the subject image more in a first direction orthogonal to the optical axis than in a second direction orthogonal to the optical axis,
the optical image stabilizer corrects a rotational shake in a rotational direction about the optical axis, and
the electronic image stabilizer corrects a shearing resulting from compression of the subject image by the optical system in a state where the rotational shake is corrected by the optical image stabilizer.

2. The imaging apparatus according to claim 1, wherein the controller changes a ratio of an electronic correction amount of the electronic image stabilizer to a sum of an optical correction amount of the optical image stabilizer and the electronic correction amount, depending on an exposure time in image capturing performed by the image sensor.

3. The imaging apparatus according to claim 2, wherein the controller decreases, as the exposure time becomes longer, the ratio of the electronic correction amount to the sum of the optical correction amount and the electronic correction amount.

4. The imaging apparatus according to claim 1, wherein the imaging apparatus corrects a rotational shake having a magnitude of 1° or more.

5. The imaging apparatus according to claim 1, wherein
the optical image stabilizer corrects at least a part of the rotational shake, and
the electronic image stabilizer corrects the shearing associated with the rotational shake without rotating the subject image for a portion of the rotational shake corrected by the optical image stabilizer.

6. The imaging apparatus according to claim 1, wherein the electronic image stabilizer corrects the shearing without correcting the rotational shake.

7. The imaging apparatus according to claim 1, wherein the optical system includes an anamorphic lens.

8. The imaging apparatus according to claim 7, wherein
the optical image stabilizer corrects the rotational shake by rotating the image sensor by an angle θₒₚₜ represented by formula (1) in the rotational direction,
$${θ}_{opt} = {tan}^{- 1} ( β tan θ ) , \qquad ( 1 )$$
wherein θ is a rotation angle of the rotational shake, and β is an anamorphic magnification of the anamorphic lens.

9. The imaging apparatus according to claim 1, wherein the electronic image stabilizer corrects the shearing by performing the image processing based on a result of a rotational shake correction of the optical image stabilizer.

10. The imaging apparatus according to claim 1, wherein
the optical image stabilizer corrects the rotational shake in a first period, and
the electronic image stabilizer corrects the shearing by performing the image processing in a second period, and
the first period is shorter than the second period.

11. The imaging apparatus according to claim 10, wherein
the second period is a frame period in which the image sensor generates image data for each frame, and
the electronic image stabilizer performs the image processing by changing a correction amount for correcting the shearing within a range of the frame period, based on a result of the rotational shake correction of the optical image stabilizer.

12. The imaging apparatus according to claim 1, further comprising a connector that removably connects an interchangeable lens, wherein
the optical system is included in the interchangeable lens.

13. The imaging apparatus according to claim 12, wherein the controller is configured to:
cause the optical image stabilizer to correct the rotational shake without causing the electronic image stabilizer to correct the shearing when the interchangeable lens connected to the connector does not include the optical system; and
cause the optical image stabilizer to correct the rotational shake, and to cause the electronic image stabilizer to correct the shearing, when the interchangeable lens connected to the connector includes the optical system.
